(19) United States
(12) Patent Application Publication
(10) Pub. No.: US 2026/0291370 A1
(43) Pub. Date: Sep. 24, 2026

(54) FLY-CAP REFRESH CIRCUIT FOR BUCK-BOOST CONVERTER

(71) Applicant: Samsung Electronics Co., Ltd., Suwon-si (KR)

(72) Inventors: Sanampalle GOWTHAM, Bengaluru (IN); Kishan Reddy GONAPATI, Bengaluru (IN); Kamalapuram ADINARAYANA, Bengaluru (IN)

(73) Assignee: Samsung Electronics Co., Ltd., Suwon-si (KR)

(21) Appl. No.: 19/226,538

(22) Filed: Jun. 3, 2025

(30) Foreign Application Priority Data
Mar. 21, 2025 (IN) 202541025857

(51) Int. Cl. H02M 1/00; H02M 3/158

(52) U.S. Cl. CPC H02M 1/0095; H02M 1/0019; H02M 3/1582

(57) ABSTRACT

A fly-cap refresh circuit for a buck-boost converter is disclosed herein. The fly-cap refresh circuit includes a first fly capacitor, a second fly capacitor and a plurality of refresh switches. The first fly capacitor is connected to a buck capacitor of a buck converter of the buck-boost converter, and configured to prevent a discharge of the buck capacitor during one or more idle periods of a first switching node. The second fly capacitor is connected to a boost capacitor of a boost converter of the buck-boost converter, and configured to prevent a discharge of the boost capacitor during the one or more idle periods of the first switching node. The plurality of refresh switches are configured to activate based on an operational mode of the buck-boost converter to control enabling the fly-cap refresh circuit.

### CROSS-REFERENCE TO RELATED APPLICATION

This application claims priority to and the benefit of Indian Patent Application number 202541025857 filed at the Indian Intellectual Property Office on Mar. 21, 2025, the entire contents of which are incorporated herein by reference.

### FIELD OF THE INVENTION

Example embodiments of inventive concepts generally relate to the field of electronic devices, and more specifically relate to a fly-cap refresh circuit for a buck-boost converter.

### BACKGROUND

A buck-boost converter is a type of Direct Current (DC)-DC converter that may have the versatility to step down (buck) or step up (boost) an input voltage to achieve a desired output voltage. This versatility may be essential (or advantageous) for applications where the input voltage may be either higher or lower than a required (or desired) output voltage, making it a critical (or beneficial) component in various power management systems. Buck-boost converters may be used in battery management systems, where the buck-boost converters regulate voltage levels as battery discharge characteristics change, and in renewable energy systems, for example, in solar power systems, where buck-boost converters may be configured to optimize (or improve, or increase) energy harvested from solar panels. Additionally, the buck-boost converters may be employed in, for example, mobiles, laptops, battery adapters, and/or electric vehicles, where buck-boost converters may be used to manage power flow between the battery and electronic devices and/or an electrical motor, which may provide (or ensure) an efficient operation (or more efficient operation) under varying load conditions.

A typical buck-boost converter includes several hardware components (or key hardware components), including an inductor that stores energy and may facilitate energy transfer, one or more capacitors that may smooth the output voltage and provide energy storage, and switches (e.g., Metal-Oxide-Semiconductor Field-Effect Transistor (MOSFETs) or Insulated-Gate Bipolar Transistor (IGBTs)) that may control current flow through the inductor. One or more diodes may also be integral to the buck-boost converter, providing a path for current when the switches are off and preventing (or reducing) backflow. Additionally or alternatively, the buck-boost converter may include a control circuitry that regulates one or more operations of the switches based on feedback from the output voltage to maintain the desired output level.

In the context of the buck-boost converter, a four-switch buck-boost converter is a configuration that utilizes four switches to achieve bidirectional voltage conversion, as illustrated in FIG. 1A and FIG. 1B. This design may enhance (or improve) efficiency and reduce component count compared to traditional converters, which may allow for (or enable) seamless transitions between buck and boost modes. In other words, the buck-boost converters, for example, a four-switch variant, may play a vital role in modern power electronics, enabling efficient (or improved, or more efficient) voltage regulation across a wide range of applications and conditions. However, several problems are encountered in the existing four-switch buck-boost converter, which are mentioned below.

FIG. 1A and FIG. 1B illustrates a four-switch buck-boost converter operating in two distinct modes correspondingly a Continuous Conduction Mode (CCM) and a Pulse Frequency Modulation (PFM), according to conventional arts.

The four-switch buck-boost converter includes power switches (e.g., SW1, SW2, SW3, and SW4), which are typically implemented, for example, using either n-channel MOSFETs or IGBT devices. The SW1 is referred to as a “high-side buck switch”, while the SW2 is referred to as a “low-side buck switch”. Conversely, the SW3 is referred to as a “low-side boost switch”, and the SW4 is referred to as a “high-side boost switch”. The configuration of the SW1 and SW2 may operate as a buck converter, whereas the configuration of the SW3 and SW4 may operate as a boost converter. This arrangement allows (or enables) for the regulation of output voltage through step-down and step-up power conversion, respectively, with both converters interconnected via an inductor. This configuration may result in a buck-boost converter, commonly referred to as a “non-inverting buck-boost converter”.

Moreover, the four-switch buck-boost converter may be designed with a bootstrap architecture, indicated by references “1” and “2,” to supply a voltage of vin+5V to the respective switches during their operational modes. The buck-boost converter may operate in three distinct operational modes, for example, a buck mode, a boost mode, and a buck-boost mode. Furthermore, the operational mode may be classified based on load current conditions. For example, when the load current is high, the converter operates in the CCM; conversely, if the load current is low, it transitions to the PFM mode. Each mode may have a specific configuration of the switches (e.g., on or off).

For instance, in a buck mode CCM configuration, as illustrated in FIG. 1A, the SW1 and SW2 continuously toggle, while the SW3 remains in the OFF state. If the SW3 were to be activated, the output voltage (Vout) would drop to zero. Thus, the SW3 is kept in an OFF state, and the SW4 remains in an ON state, resulting in Vout equating to VLX_BOOST. During the initial stages, the voltage across capacitor “Cb2” may stabilize at approximately 4.6V, assuming an input voltage of 5V with a 0.4V drop across the diode. Given a supply voltage (VDD_ext) of 5V, reverse leakage may occur, causing the voltage across the Cb2 to decline potentially from 4.6V to 4.5V, then to 3V, and subsequently to 1V. Once the voltage across the Cb2 falls below a certain threshold (e.g., 1V), the SW4 will deactivate, which may be undesirable in the buck mode CCM configuration. In essence, capacitor CB2 may discharge over time within the bootstrap architecture, as indicated by reference “2,” which may not be conducive to the buck mode CCM operation.

For another instance, during a boost mode CCM configuration (not depicted in FIG. 1A), the SW3 and SW4 continuously toggle, while the SW2 remains grounded (OFF). The SW1 is kept in the ON state, resulting in a gate voltage of vin+4.6V due to the bootstrap architecture (reference “1”). Initially, the voltage across the capacitor “Cb1” may stabilize at approximately 4.6V, with an input voltage of 5V and a 0.4V drop across the diode. Given a supply voltage (VDD_ext) of 5V, reverse leakage may also occur, leading to a gradual decrease in the voltage across Cb1 from 4.6V to 4.5V, then to 3V, and finally to 1V. Once this voltage drops to a critical level (e.g., 1V), the SW1 will turn OFF, which may not be ideal for the boost mode CCM configuration. Thus, capacitor Cb1 may discharge over time within the bootstrap architecture (reference “1”), which may poses challenges for maintaining performance in the boost mode CCM configuration.

For another instance, during a buck mode PFM configuration, as illustrated in FIG. 1B, a duty cycle applied is notably low (e.g., 20%). Consequently, capacitors Cb1 and Cb2 may experience gradual discharge, leading to an inability of the buck mode PFM configuration to function effectively (or properly) with the required switch configuration, which may also be undesirable. Given the consistent discharge of the bootstrap capacitors (Cb1 and Cb2) across all aforementioned scenarios, an effective refreshing technique (or a technique) may be essential (or beneficial) to recharge the bootstrap capacitors (Cb1 and Cb2) across all operational modes without compromising the performance (or operability) of the buck-boost converter.

Thus, it may be desired to address the above-mentioned disadvantages or other shortcomings or at least provide a useful alternative for the buck-boost converter.

### SUMMARY

This summary is provided to introduce a selection of concepts, in a simplified format, that are further described in the detailed description of the present specification. This summary is neither intended to identify key or essential (or beneficial) concepts of the present inventive concepts nor is it intended for determining the scope of example embodiments.

Some example embodiments of inventive concepts provide a fly-cap refresh circuit for a buck-boost converter, including a first fly capacitor connected to a buck capacitor of a buck converter of the buck-boost converter, and configured to prevent a discharge of the buck capacitor during one or more idle periods of a first switching node, a second fly capacitor connected to a boost capacitor of a boost converter of the buck-boost converter, and configured to prevent a discharge of the boost capacitor during the one or more idle periods of the first switching node, and a plurality of refresh switches connected between at least one of the first fly capacitor and the buck capacitor, the second fly capacitor and the boost capacitor, the first fly capacitor and a ground node, and the second fly capacitor and the ground node, wherein the plurality of refresh switches are configured to activate based on an operational mode of the buck-boost converter to control enabling the fly-cap refresh circuit, and wherein the operational mode includes at least one of a Continuous Conduction Mode (CCM) or a Pulse Frequency Modulation (PFM) mode.

Some example embodiments of inventive concepts provide a system including first fly capacitor connected to a buck capacitor of a buck converter of a buck-boost converter, and configured to prevent a discharge of the buck capacitor during one or more idle periods of a first switching node, a second fly capacitor connected to a boost capacitor of a boost converter of the buck-boost converter, and configured to prevent a discharge of the boost capacitor during the one or more idle periods of the first switching node, and a plurality of refresh switches connected between at least one of the first fly capacitor and the buck capacitor, the second fly capacitor and the boost capacitor, the first fly capacitor and a ground node, and the second fly capacitor and the ground node, wherein the plurality of refresh switches are configured to activate based on an operational mode of the buck-boost converter to control enabling of a fly-cap refresh circuit of the buck-boost converter, and wherein the operational mode comprises at least one of a Continuous Conduction Mode (CCM) or a Pulse Frequency Modulation (PFM) mode.

To further clarify the advantages and features of the present inventive concepts, a more particular description of the present inventive concepts will be rendered by reference to some example embodiments thereof, which are illustrated in the appended drawings. It is appreciated that these drawings depict only typical example embodiments of the inventive concepts and are therefore not to be considered limiting of its scope. Some example embodiments of inventive concepts will be described and explained with additional specificity and detail in the accompanying drawings.

### BRIEF DESCRIPTION OF THE DRAWINGS

These and other features, aspects, and advantages of the present inventive concepts will become better understood when the following detailed description is read with reference to the accompanying drawings in which like characters represent like parts throughout the drawings, wherein:

FIGS. 1A-1B illustrates a four-switch buck-boost converter operating in two distinct modes correspondingly a Continuous Conduction Mode (CCM) and a Pulse Frequency Modulation (PFM), according to conventional arts;

FIG. 2 illustrates a circuit diagram of a fly-cap refresh circuit for a buck-boost converter, according to some example embodiments;

FIG. 3 illustrates a mathematical analysis associated with the fly-cap refresh circuit for the buck-boost converter, according to some example embodiments;

FIG. 4 illustrates a circuit diagram of the fly-cap refresh circuit for the buck-boost converter in a CCM buck mode along with one or more signaling inputs to perform one or more operations, according to some example embodiments; and

FIGS. 5A-5B illustrates a circuit diagram of the fly-cap refresh circuit for the buck-boost converter in a PFM buck mode along with one or more signaling inputs to perform one or more operations, according to some example embodiments.

Further, skilled artisans will appreciate that elements in the drawings are illustrated for simplicity and may not have necessarily been drawn to scale. For example, the flow charts illustrate the method in terms of the most prominent steps (or operations) involved to help to improve understanding of aspects of the present inventive concepts. Furthermore, in terms of the construction of example embodiments, one or more components of example embodiments may have been represented in the drawings by conventional symbols, and the drawings may show only those specific details that are pertinent to understanding some example embodiments of the present inventive concepts so as not to obscure the drawings with details that will be readily apparent to those of ordinary skill in the art having the benefit of the description herein.

### DETAILED DESCRIPTION

For the purpose of promoting an understanding of the principles of the present inventive concepts, reference will now be made to some example embodiments illustrated in the drawings and specific language will be used to describe the same. It will nevertheless be understood that no limitation of the scope of the present inventive concepts is thereby intended, such alterations and further modifications in the illustrated system, and such further applications of the principles of the present inventive concepts as illustrated therein being contemplated as would normally occur to one skilled in the art to which the present inventive concepts relate.

It will be understood by those skilled in the art that the foregoing general description and the following detailed description are explanatory of the present inventive concepts and are not intended to be restrictive thereof.

Reference throughout this specification to “an aspect”, “another aspect” or similar language means that a particular feature, structure, or characteristic described in connection with example embodiments is included in at least one example embodiment of the present inventive concepts. Thus, appearances of the phrase “in an embodiment”, “in one embodiment”, “in another embodiment”, “in some example embodiments,” and similar language throughout this specification may, but do not necessarily, all refer to the same example embodiment.

The terms “comprise”, “comprising”, “includes,” “including,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The example embodiments herein and the various features and advantageous details thereof are explained more fully with reference to the non-limiting example embodiments that are illustrated in the accompanying drawings and detailed in the following description.

Descriptions of well-known components and processing techniques are omitted so as to not unnecessarily obscure the embodiments herein. Also, the various example embodiments described herein are not necessarily mutually exclusive, as some example embodiments can be combined with one or more other example embodiments to form new example embodiments. The term “or” as used herein, refers to a non-exclusive or unless otherwise indicated. The examples used herein are intended merely to facilitate an understanding of ways in which the example embodiments herein can be practiced and to further enable those skilled in the art to practice the example embodiments herein. Accordingly, the examples should not be construed as limiting the scope of the example embodiments herein.

As is traditional in the field, some example embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the example embodiments may be physically separated into two or more interacting and discrete blocks without departing from the scope of the invention. Likewise, the blocks of the example embodiments may be physically combined into more complex blocks without departing from the scope of the present inventive concepts.

The accompanying drawings are used to help easily understand various technical features and it should be understood that the example embodiments presented herein are not limited by the accompanying drawings. As such, the present inventive concepts should be construed to extend to any alterations, equivalents, and substitutes in addition to those which are particularly set out in the accompanying drawings. Although the terms first, second, etc., may be used herein to describe various elements, these elements should not be limited by these terms. These terms are generally only used to distinguish one element from another.

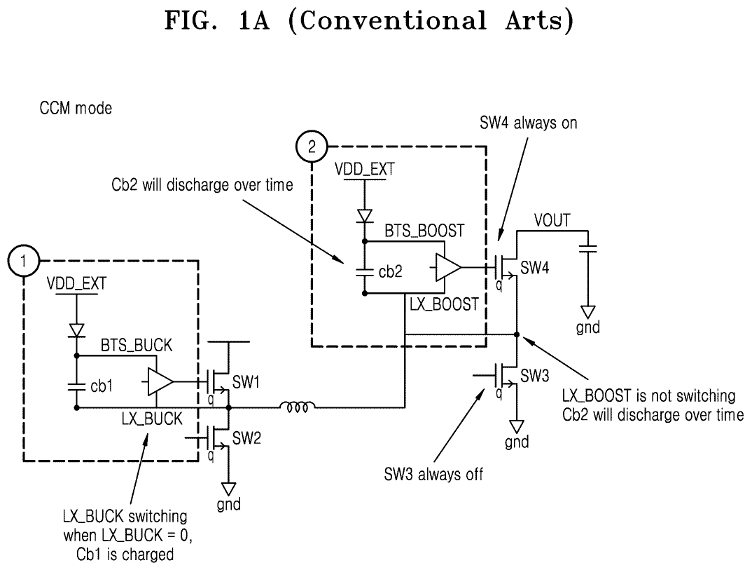

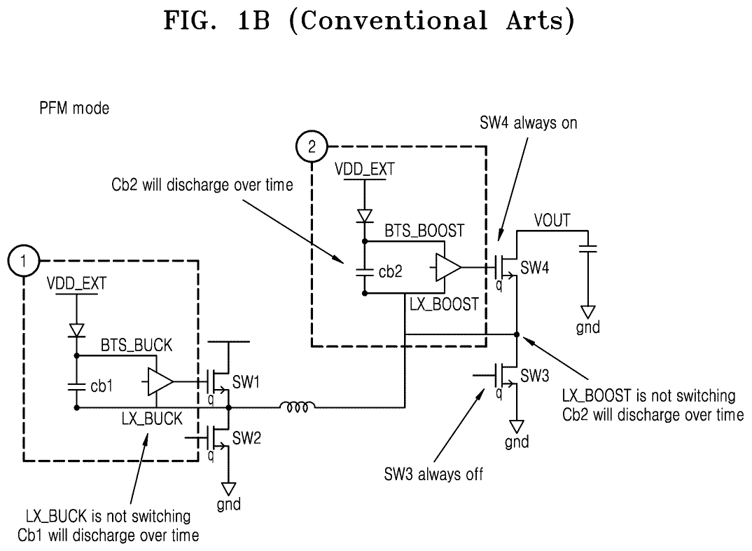

In the proposed architecture, an auxiliary fly capacitor circuit may be integrated alongside control switches to periodically refresh a primary bootstrap capacitor (e.g., Cb1 and Cb2) of the buck and boost converters, as discussed throughout the present specification. This refresh mechanism may be driven by an oscillator, enabling operation in both Continuous Conduction Mode (CCM) and Pulse Frequency Modulation (PFM). The design may be optimized (or improved) for reduced footprint and lower quiescent current (IQ), thereby facilitating enhanced (or improved) performance (and/or power consumption) relative to traditional legacy architectures in conventional arts, which may refer to FIGS. 1A-1B. Additionally or alternatively, the proposed architecture may support operation in both PFM and CCM, in contrast to prior legacy architectures in conventional arts that were limited to CCM operations exclusively.

When the terms “approximately” or “about” are used in this specification in connection with a numerical value, it is intended that the associated numerical value includes a manufacturing or operational tolerance (e.g., +10%) around the stated numerical value. Moreover, when the words “approximately” and “about” are used in connection with geometric shapes, it is intended that precision of the geometric shape is not required but that latitude for the shape is within the scope of the disclosure. Further, regardless of whether numerical values or shapes are modified as “approximately” or “about” it will be understood that these values and shapes should be construed as including a manufacturing or operational tolerance (e.g., +10%) around the stated numerical values or shapes.

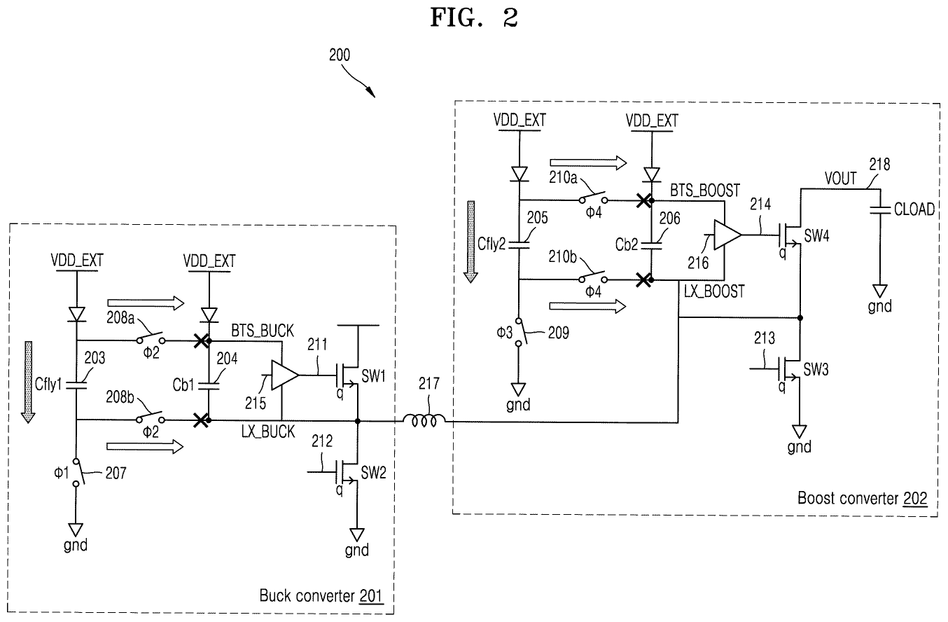

Referring now to the drawings, and more particularly to FIGS. 2 to 5B, similar reference characters denote corresponding features consistently throughout the figures.

FIG. 2 illustrates a circuit diagram of a fly-cap refresh circuit 200 for a buck-boost converter, according to some example embodiments.

The fly-cap refresh circuit 200 may include a buck converter 201 and a boost converter 202. Both converters may interconnect via an inductor 217, and may be known as the buck-boost converter. The buck-boost converter may include various hardware components such as a first fly capacitor (C_{fly1}) 203 (e.g., approximately 250 pF), a buck capacitor (C_{b1}) 204 (e.g., approximately 100 nF), a second fly capacitor (C_{fly2}) 205 (e.g., approximately 250 pF), a boost capacitor (C_{b2}) 206 (e.g., approximately 100 nF), a plurality of refresh switches (Φ₁, Φ₂, Φ₃, Φ₄) (e.g., 207, 208a, 208b, 209, 210a, and 210b), a first gate connector 215, a second gate connector 216, the inductor 217, and power switches (e.g., SW1, SW2, SW3, and SW4) (e.g., 211, 212, 213, and 214).

These hardware components may be configured to facilitate an effective refresh mechanism essential (or used, or beneficial) for recharging the bootstrap capacitors (e.g., Cb1 204 and Cb2 206) across all operational modes (e.g., buck mode, boost mode, etc.), while maintaining the performance integrity of the buck-boost converter. In some example embodiments, challenges faced by existing four-switch buck-boost converters in sustaining performance across various operational modes by ensuring a specific interconnection and functionality for each hardware component may be addressed, as detailed below.

In one or more example embodiments, the first fly capacitor (C_{fly1}) 203 may be connected to the buck capacitor (C_{b1}) 204 of the buck converter 201 of the buck-boost converter, and may be configured to prevent (or reduce a likelihood of) a discharge of the buck capacitor (C_{b1}) 204 during one or more idle periods of a switching node (e.g., Lx_buck). The second fly capacitor (C_{fly2}) 205 may be connected to the boost capacitor (C_{b2}) 206 of the boost converter 202 of the buck-boost converter, and may be configured to prevent (or reduce a likelihood of) a discharge of the boost capacitor (C_{b2}) 206 during the one or more idle periods of the switching node (e.g., Lx_boost). The switching node of the buck converter 201 may be controlled based on a duty of the buck converter 201 and a load current, where the switching node remains in an idle state for an extended period (of time) when the load current is low (or very low).

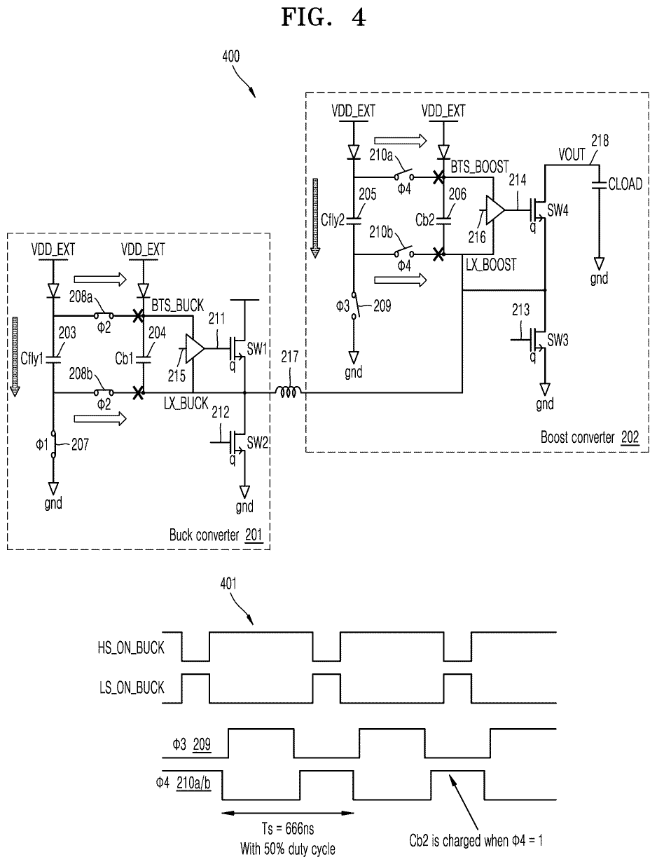

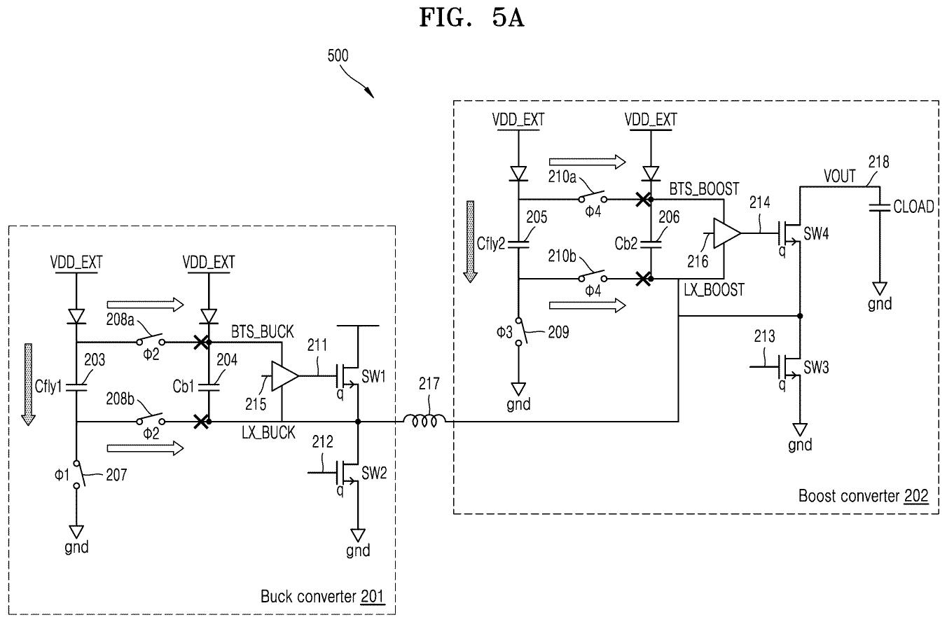

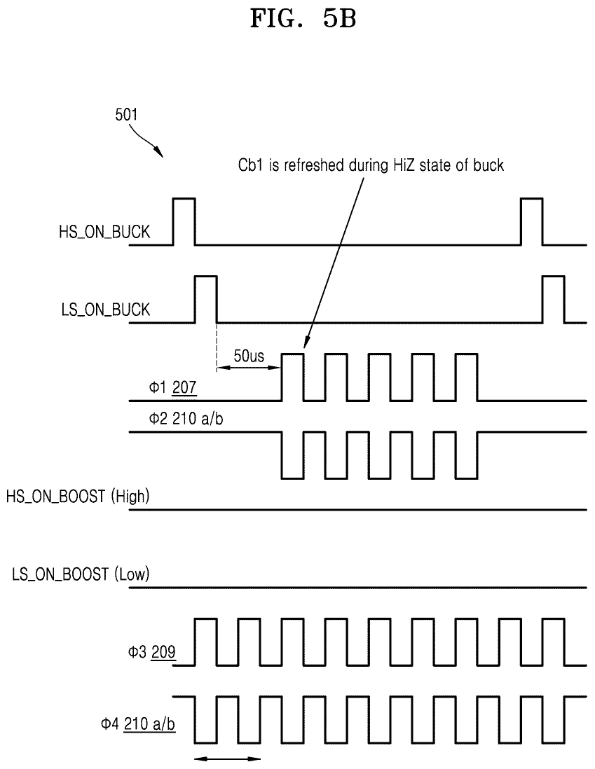

In one or more example embodiments, the first and second fly capacitors (C_{fly1} 203 and C_{fly2} 205) may be configured to store a charge during one or more active switching periods to keep steady a voltage level of the buck and boost capacitors (C_{b1} 204 and C_{b2} 206), as described in conjunction with FIG. 4 and FIGS. 5A-5B. In other words, the first fly capacitor (C_{fly1}) 203 may be configured to store charge and supply charge to the buck capacitor (C_{b1}) 204 of the buck converter 201. The second fly capacitor (C_{fly2} 205) may be configured to store charge and supply charge to the boost capacitor (C_{b2}) 206 of the boost converter 202. The buck and boost capacitors (C_{b1} 204 and C_{b2} 206) may be charged by the corresponding first and second fly capacitors (C_{fly1} 203 and C_{fly2} 205) during one or more switching operations associated with a plurality of N-channel N-type Power Field-Effect Transistor (PWRFET) switches (e.g., SW1) of the buck-boost converter, to provide a consistent gate drive voltage to the plurality of refresh switches.

In one or more example embodiments, the plurality of refresh switches (Φ₁, Φ₂, Φ₃, Φ₄) (e.g., 207, 208a, 208b, 209, 210a, and 210b) may be connected between at least one of the first fly capacitor (C_{fly1}) 203 and the buck capacitor (C_{b1}) 204, the second fly capacitor (C_{fly2}) 205 and the boost capacitor (C_{b2}) 206, the first fly capacitor (C_{fly1}) 203 and a ground node, and the second fly capacitor (C_{fly2}) 205 and the ground node. One or more clock signals may be configured to control the plurality of refresh switches (Φ₁, Φ₂, Φ₃, Φ₄) (e.g., 207, 208a, 208b, 209, 210a, and 210b), as described in conjunction with FIG. 4 and FIG. 5B. The plurality of refresh switches (Φ₁, Φ₂, Φ₃, Φ₄) (e.g., 207, 208a, 208b, 209, 210a, and 210b) may be configured to refresh a charge in the buck and boost capacitors (C_{b1} 204 and C_{b2} 206) and to optimize (or improve) a performance of the buck-boost converter.

In one or more example embodiments, a first refresh switch (Φ₁) 207 of the plurality of refresh switches may be configured to activate and charge the first fly capacitor (C_{fly1}) 203 to an external voltage source (VDD_EXT) minus a diode drop. A second refresh switch (Φ₂) (208a and 20b) of the plurality of refresh switches may be configured to activate and transfer charge from the first fly capacitor (C_{fly1}) 203 to the buck capacitor (C_{b1}) 204. A third refresh switch (Φ₃) 209 of the plurality of refresh switches may be configured to activate and charge the second fly capacitor (C_{fly2}) 205 to the external voltage source VDD_EXT minus the diode drop. A fourth refresh switch (Φ₄) (210a and 210b) of the plurality of refresh switches may be configured to activate and transfer charge from the second fly capacitor (C_{fly2}) 205 to the boost capacitor (C_{b2}) 206.

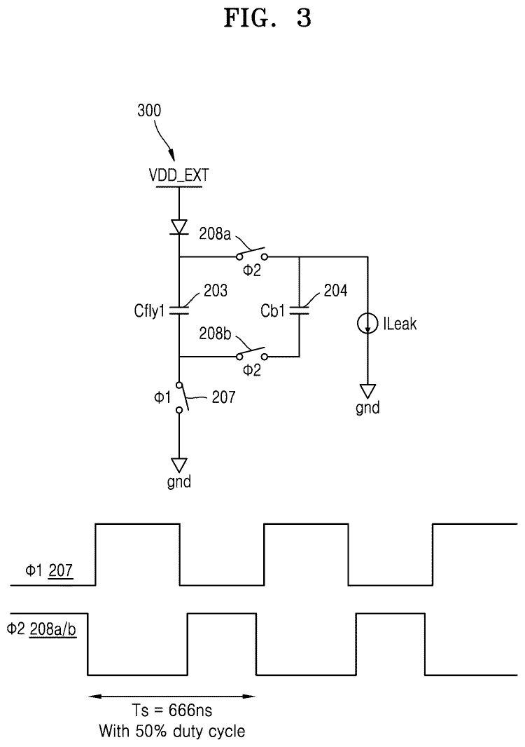

In one or more example embodiments, the plurality of refresh switches (Φ₁, Φ₂, Φ₃, Φ4) (e.g., 207, 208a, 208b, 209, 210a, and 210b) may be configured to activate based on an operational mode of the buck-boost converter to control the enabling of the fly-cap refresh circuit, as described in conjunction with FIG. 3, FIG. 4 and FIGS. 5A-5B. The operational mode comprises at least one of a Continuous Conduction Mode (CCM) or a Pulse Frequency Modulation (PFM) mode.

In one or more example embodiments, the first gate connector 215 may be connected to the buck capacitor (Cb₁) 204 of the buck converter 201 of the buck-boost converter, and may be configured to provide a unidirectional path for current, enabling energy transfer from the inductor (L) 217 to a first output during a first switch-off phase of the buck section (e.g., 201). The second gate connector 216 may be connected to the boost capacitor (Cb₂) 206 of the boost converter 202 of the buck-boost converter, and may be configured to provide a unidirectional path for current, enabling energy stored in the inductor (L) 217 to transfer a second output during a second switch-off phase of the boost section (e.g., 202).

In one or more example embodiments, the inductor 217 may be configured to store energy during a charging phase and release the stored energy during a discharging phase of the buck-boost converter. Additionally or alternatively, the inductor 217 may be configured to enable a voltage step-up and a voltage step-down functionality of the buck-boost converter while regulating a current flow to maintain an output voltage (or a stable output voltage) and minimize or reduce energy losses.

Although FIG. 2 shows various hardware components of the fly-cap refresh circuit 200, example embodiments are not limited thereto. In some example embodiments, the fly-cap refresh circuit 200 may include less or more number of components. Further, the labels or names of the components are used only for illustrative purposes and do not limit the scope of the present inventive concepts. One or more components can be combined to perform the same or substantially similar functions to provide the effective refresh mechanism essential (or beneficial) for recharging the bootstrap capacitors (e.g., Cb1 204 and Cb2 206) across all operational modes (e.g., buck mode, boost mode, etc.).

FIG. 3 illustrates a mathematical analysis associated with the fly-cap refresh circuit for the buck-boost converter, according to some example embodiments.

Circuit 300 may be a part of the fly-cap refresh circuit design that incorporates the fly capacitor (C_{fly1}) 203 and a non-overlap clock mechanism (Φ₁, Φ₂) (e.g., 208a and 208b). The fly capacitor (C_{fly1}) 203 may be used to provide an effective refreshing mechanism for the bootstrap capacitors (C_{b1}) 204 across all operational modes, such as buck mode and boost mode. The non-overlap clock signals (Φ₁, Φ₂) may be used to control the switching of the circuit in a way that ensures the bootstrap capacitors are properly recharged during each cycle.

In some example embodiments, when an input voltage (VDD_EXT) supply is applied to the circuit 300, a diode may be used to rectify the input voltage and provide a unidirectional current path to charge the bootstrap capacitor (C_{b1}) 204. The fly capacitor (C_{fly1}) 203 may be charged during one phase of the non-overlap clock (Φ₁, Φ₂) (e.g., 208a and 208b) and discharged to refresh the bootstrap capacitor (C_{b1}) during the other phase. The bootstrap capacitor (Cb1) may be charged by the VDD_EXT supply through the diode and may provide the necessary voltage to drive the gate of the power switch (not shown in FIG. 3) during the buck-boost operation. The non-overlap clock signals (Φ₁, Φ₂) (e.g., 208a and 208b) may control the switching of the circuit, ensuring that the bootstrap capacitor is recharged (or properly recharged) during each cycle and preventing (or reducing) short-circuit conditions. As a result, a final settled value of the output voltage (Vo) may be calculated based on the VDD_EXT, a forward voltage of the diode (VF), a leakage current (ILeak), and a refreshing frequency for the boot-strap capacitor (f_bts), as shown in equation-1 below.

$$Vo = ( VDD\_EXT - V F ) - \frac{ILeak}{f\_bts . {C}_{fly 1}} \qquad ( 1 )$$

Accordingly, the buck-boost converter design with the fly capacitor and non-overlap clock mechanism may help ensure the reliable operation of the bootstrap capacitors, which may be crucial (or relevant) for the overall performance and efficiency of the buck-boost converter across different modes of operation.

FIG. 4 illustrates a circuit diagram 400 of the fly-cap refresh circuit for the buck-boost converter in a CCM buck mode (i.e., buck mode CCM configuration) along with one or more signaling inputs 401 to perform one or more operations, according to some example embodiments.

The buck-boost converter depicted in FIG. 4 may be configured to operate in the CCM buck mode, which represents the operational mode for the buck converter. A supply voltage source (VDD_EXT) may be configured to provide power to the buck-boost converter. The circuit depicted in FIG. 4 may utilize the plurality of switches (e.g., 211, 212, 213, and 214) to manage the flow of current within the buck-boost converter. Each of these switches may be an N-channel N-type Power Field-Effect Transistor (PWRFET) switch, but embodiments are not limited thereto. The plurality of switches (e.g., 211, 212, 213, and 214) may include a first switch (SW₁) 211, a second switch (SW₂) 212, a third switch (SW₃) 213, and a fourth switch (SW₄) 214.

In the CCM buck mode, the first switch (SW₁) 211 and the second switch (SW₂) 212 may be configured to perform switching (LX_BUCK switching) based on the HS_ON_BUCK and LS_ON_BUCK control signals 401, resulting in their continuous toggling. Conversely, the third switch (SW₃) 213 may be maintained in the OFF state, while the fourth switch (SW₄) 214 may be kept in the ON state.

In some example embodiments, during the LX_BUCK switching, the buck capacitor (Cb1) 204 may be continuously recharged as the LX_BUCK switching node alternately connects to the VDD_EXT and ground, allowing the buck capacitor (Cb1) 204 to charge based on this switching. Additionally or alternatively, the boost capacitor (Cb2) 206 may be configured to charge based on the operation of the plurality of refresh switches (Φ3 and Φ4) (e.g., 209, 210a, and 210b) with a predefined total period (Ts) and duty cycle. The first and second fly capacitors (C_{fly1} 203 and C_{fly2} 205), as well as the buck and boost capacitors (C_{b1} 204 and C_{b2} 206), may be designed to stabilize the output voltage (VOUT) 218 of the buck-boost converter. The buck capacitor (C_{b1}) may be charged by the inductor (LX_BUCK), while the boost capacitor (C_{b2}) may be charged by the plurality of refresh switches (Φ3 and Φ4). As a result, the stabilized output voltage (VOUT) 218 may be delivered to the connected load (Cload), and no reverse voltage leakage occurs across the C_{b2} capacitor, which is a desirable characteristic in the CCM buck mode configuration.

The buck-boost converter depicted in FIG. 4 may be configured to operate in the CCM boost mode, which represents the operational mode for the boost converter (not shown in FIG. 4). The supply voltage source (VDD_EXT) may be configured to provide power to the buck-boost converter. The circuit depicted in FIG. 4 may be configured to utilize the plurality of switches (e.g., 211, 212, 213, and 214) to manage the flow of current within the buck-boost converter. Each of these switches may be an N-channel N-type PWRFET switch, but example embodiments are not limited thereto.

In the CCM boost mode, the third switch (SW₃) 213 and the fourth switch (SW₄) 214 may be configured to perform switching (LX_BOOST switching) based on the HS_ON_BOOST and LS_ON_BOOST control signals, resulting in their continuous toggling. Conversely, the first switch (SW₁) 211 may be maintained in the ON state, while the second switch (SW₂) 212 may be kept in the OFF state.

In some example embodiments, during the LX_BOOST switching, the boost capacitor (Cb2) 206 may be continuously recharged as the LX_BOOST switching node alternately connects to the VDD_EXT and ground, allowing the boost capacitor (Cb2) 206 to charge based on this switching. Additionally or alternatively, the buck capacitor (Cb1) 204 may be configured to charge based on the operation of the plurality of refresh switches (Φ1 and Φ2) (e.g., 207, 208a, and 208b) with a predefined total period (Ts) and duty cycle. The first and second fly capacitors (C_{fly1} 203 and C_{fly2} 205), as well as the buck and boost capacitors (C_{b1} 204 and C_{b2} 206), may be designed to stabilize the output voltage (VOUT) 218 of the buck-boost converter. The boost capacitor (Cb2) may be charged by the inductor (LX_BOOST), while the buck capacitor (Cb1) may be charged by the plurality of refresh switches (Φ1 and Φ2). As a result, the stabilized output voltage (V_{OUT}) 218 may be delivered to the connected load (Cload), and no reverse voltage leakage occurs across the Cb1 capacitor, which is a desirable characteristic in the CCM boost mode configuration.

In one or more example embodiments, the fly capacitor circuit may provide the effective refresh mechanism essential (or used, or beneficial) for recharging the bootstrap capacitors (e.g., Cb1 204 and Cb2 206) across all operational modes (e.g., buck mode, boost mode, etc.) for the CCM, while maintaining the performance integrity of the buck-boost converter. This design may address the challenges faced by existing four-switch buck-boost converters in sustaining performance across various operational modes by ensuring a specific interconnection and functionality for each hardware component, for example, details are given in Table-1 below.

TABLE 1

| | | Specific Interconnection and |
|---|---|---|
| Modes | Switching | Functionality |
| Buck mode | SW1, SW2 switching, | Cb1 charged by LX_BUCK |
| CCM | SW4 always on, | switching |
| | SW3 always off | Cb2 charged by Φ3 and Φ4 |
| | | switching |
| | | Φ3 and Φ4 switching with |
| | | Ts = 666 ns with |
| | | 50% duty cycle |
| Boost mode | SW3, SW4 switching, | Cb2 charged by LX_BOOST |
| CCM | SW1 always on, | switching |
| | SW2 always off | Cb1 charged by Φ1 and Φ2 |
| | | switching |
| Buck-Boost | SW1, SW2 switching | Cb1 charged by LX_BUCK |
| mode CCM | SW3, SW4 also | switching |
| | switching | Cb2 charged by LX_BOOST |
| | | switching |

FIGS. 5A-5B illustrates a circuit diagram 500 of the fly-cap refresh circuit for the buck-boost converter in a PFM buck mode along with one or more signaling inputs 501 to perform one or more operations, according to some example embodiments.

The buck-boost converter depicted in FIG. 5A may be configured to operate in the PFM buck mode, which represents the operational mode of the buck-boost converter as the CCM. A supply voltage source (VDD_EXT) may be configured to provide power to the buck-boost converter. The circuit in FIG. 5A may be configured to utilize the plurality of switches (e.g., 211, 212, 213, 214) to manage the flow of current within the buck-boost converter. Each of these switches is the N-channel N-type PWRFET switch, but example embodiments are not limited thereto.

In the PFM buck mode, the refreshing of the buck capacitor (Cb1) 204 may be done during a HiZ mode, which occurs after the LS_ON_BUCK signal goes low. In contrast, the refreshing of the boost capacitor (Cb2) 206 may be done continuously. The Φ3 and Φ4 switching signals may operate continuously to charge the boost capacitor (Cb2) 206, as shown in FIG. 5B. The refreshing clock may have a frequency of, for example, 666 ns with a duty cycle of 50%, but example embodiments are not limited thereto. The first and second fly capacitors (C_{fly1} 203 and C_{fly2} 205), as well as the buck and boost capacitors (Cb1 204 and Cb2 206), may be designed to stabilize the output voltage (V_{OUT}) of the buck-boost converter.

In the CCM mode, the switching of the first (SW1) 211 and second (SW2) 212 switches may be continuous, resulting in a flow of current (or in a steady flow of current) through the inductor (LX_BUCK) and a continuous recharging of the buck capacitor (C_{b1}) 204. In contrast, the PFM mode may exhibit intermittent switching of SW1 211 and SW2 212, leading to a pulsed recharging of the Cb1 204. Additionally or alternatively, in the PFM mode, the refreshing of Cb1 204 may be done during the HiZ mode (after LS_ON_BUCK goes low), while the refreshing of Cb2 206 may be done continuously using the Φ3 and Φ4 switching signals.

In one or more example embodiments, the fly-cap refresh circuit for the buck-boost converter may have several advantages over the existing buck-boost converter. Some of the advantages are mentioned below.

Some example embodiments provide a fly-cap refresh circuit for a buck-boost converter configured to operate in both PFM and CCM modes as a result of having an architecture that may function in both a PFM mode and a CCM mode, which may provide flexibility and adaptability to different operating conditions.

Some example embodiments provide a fly-cap refresh circuit for a buck-boost converter that does not include sensing circuitry for bootstrap capacitors. Some example embodiments include a design that may eliminate the need for sensing circuitry (or may eliminate using sensing circuitry) for the bootstrap capacitor, which may often load the capacitor and impact performance, and the design may simplify the overall circuit design.

Some example embodiments provide a fly-cap refresh circuit for a buck-boost converter with a customizable fly-cap and frequency selection. Some example embodiments include a fly-cap and refresh frequency that may be selected based on the specific efficiency and area requirements of the application, which may allow for optimization (or improvement) and tailoring to different use cases.

Some example embodiments provide a fly-cap refresh circuit for a buck-boost converter which may be applicable to various DC-DC converter topologies. Some example embodiments include design techniques that may be applied to a wide range of DC-DC converter topologies, including buck, boost, and buck-boost converters. This versatility may enable a broader range of applications and products to benefit from the advantages of the fly-cap refresh circuit.

Some example embodiments provide a fly-cap refresh circuit for a buck-boost converter that may not include any LX node switching. In the absence of any LC node switching, the fly-cap refresh circuit may provide benefits without the complexities associated with the switching node, which may further simplify the overall design and implementation.

Unless otherwise defined, all technical and scientific terms used herein may have the same meaning as commonly understood by one ordinary skilled in the art to which the present inventive concepts belong. The system, methods, and examples embodiments provided herein are illustrative only and not intended to be limiting.

While specific language has been used to describe the present subject matter, any limitations arising on account thereto, are not intended. As would be apparent to a person in the art, various working modifications may be made to the method to implement the present inventive concepts as taught herein. The drawings and the forgoing description give examples of some example embodiments. Those skilled in the art will appreciate that one or more of the described elements may well be combined into a single functional element. Alternatively or additionally, certain elements may be split into multiple functional elements. Elements from one example embodiment may be added to another example embodiment.

The example embodiments disclosed herein can be implemented using at least one hardware device and performing network management functions to control the elements.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FGPA), a System-on-Chip (SoC), a programmable logic unit, a microprocessor, application-specific integrated circuit (ASIC), etc.

The foregoing description of the specific example embodiments will so fully reveal the general nature of the example embodiments herein that others can, by applying current knowledge, readily modify and/or adapt for various applications such specific example embodiments without departing from generic concepts, and, therefore, such adaptations and modifications should and are intended to be comprehended within the meaning and range of equivalents of the disclosed example embodiments. It is to be understood that the phraseology or terminology employed herein is for the purpose of description and not of limitation. Therefore, while the present inventive concepts herein have been described in terms of some example embodiments, those skilled in the art will recognize that the example embodiments herein can be practiced with modification within the scope of the example embodiments as described herein.

We claim:

1. A fly-cap refresh circuit for a buck-boost converter, comprising:
a first fly capacitor connected to a buck capacitor of a buck converter of the buck-boost converter, and configured to prevent a discharge of the buck capacitor during one or more idle periods of a first switching node;
a second fly capacitor connected to a boost capacitor of a boost converter of the buck-boost converter, and configured to prevent a discharge of the boost capacitor during the one or more idle periods of the first switching node; and
a plurality of refresh switches connected between at least one of the first fly capacitor and the buck capacitor, the second fly capacitor and the boost capacitor, the first fly capacitor and a ground node, and the second fly capacitor and the ground node,
wherein the plurality of refresh switches are configured to activate based on an operational mode of the buck-boost converter to control enabling the fly-cap refresh circuit, and
wherein the operational mode includes at least one of a Continuous Conduction Mode (CCM) or a Pulse Frequency Modulation (PFM) mode.

2. The fly-cap refresh circuit of claim 1, wherein the first and second fly capacitors are configured to store a charge during one or more active switching periods to keep a voltage level of the buck and boost capacitors.

3. The fly-cap refresh circuit of claim 1,
wherein one or more clock signals are configured to control the plurality of refresh switches; and
wherein the plurality of refresh switches are configured to refresh a charge in the buck and boost capacitors of the buck-boost converter.

4. The fly-cap refresh circuit of claim 1, wherein the buck and boost capacitors are charged by the corresponding first and second fly capacitors during one or more switching operations associated with a plurality of N-channel N-type Power Field-Effect Transistor switches of the buck-boost converter, to provide a gate drive voltage to the plurality of refresh switches.

5. The fly-cap refresh circuit of claim 1,
wherein the first fly capacitor is configured to store charge and supply charge to the buck capacitor of the buck converter;
wherein the second fly capacitor is configured to store charge and supply charge to the boost capacitor of the boost converter;
wherein a first refresh switch (Φ₁) (207) of the plurality of refresh switches is configured to activate and charge the first fly capacitor to an external voltage source minus a diode drop;
wherein a second refresh switch of the plurality of refresh switches is configured to activate and transfer charge from the first fly capacitor to the buck capacitor;
wherein a third refresh switch of the plurality of refresh switches is configured to activate and charge the second fly capacitor to the external voltage source minus the diode drop; and
wherein a fourth refresh switch of the plurality of refresh switches is configured to activate and transfer charge from the second fly capacitor to the boost capacitor.

6. The fly-cap refresh circuit of claim 1, wherein the operational mode of the buck converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the first switch and the second switch are configured to perform a buck switching based on at least one of an first signal and a second signal,
wherein the third switch is OFF, and the fourth switch is ON,
wherein during the buck switching, the buck capacitor is recharged as a second switching node associated with the first switching node operates by alternately connecting to the supply voltage source and a ground, wherein the buck capacitor is configured to charge based on the buck switching, and
wherein the boost capacitor is configured to charge based on at least two switches of the plurality of refresh switches having a time period and a duty cycle.

7. The fly-cap refresh circuit of claim 6,
wherein the first and second fly capacitors and the buck and boost capacitors are configured to stabilize an output voltage of the buck-boost converter, the buck capacitor is charged by a buck inductor, and the boost capacitor is charged by at least two refresh switches of the plurality of refresh switches; and
wherein the stabilized output voltage is delivered to a connected load, and the stabilized output voltage is determined based on one or more of the supply voltage source, a forward voltage of diode, a leak current, a refreshing frequency for boot-strap cap, and a first fly capacitor.

8. The fly-cap refresh circuit of claim 1, wherein the operational mode of the boost converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the third switch and the fourth switch are configured to perform a boost switching based on at least one of an first signal and a second signal,
wherein the first switch is ON and the second switch is OFF,
wherein during the boost switching, the buck capacitor is recharged as a second switching node associated with the first switching node operates by alternately connecting to the supply voltage source and a ground,
wherein the buck capacitor is configured to charge based on at least two refresh switches of the plurality of refresh switches having a time period and a duty cycle, and
wherein the boost capacitor is configured to charge based on the boost switching.

9. The fly-cap refresh circuit of claim 1, wherein the operational mode of the buck-boost converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the buck capacitor is configured to charge based on a buck switching; and
wherein the boost capacitor is configured to charge based on the buck switching.

10. The fly-cap refresh circuit of claim 1, wherein when the operational mode of the buck converter is the PFM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the buck capacitor is configured to charge during an idle state of a buck inductor based on continuous switching of at least two refresh switches of the plurality of refresh switches; and
wherein the boost capacitor is configured to charge during an idle state of a boost inductor based on continuous switching of at least two refresh switches of the plurality of refresh switches.

11. The fly-cap refresh circuit of claim 1, wherein the buck-boost converter further comprises:
a first gate connector connected to the buck capacitor of the buck converter of the buck-boost converter, and configured to provide a unidirectional path for current to transfer energy from an inductor to a first output during a first switch-off phase of a buck section of the buck-boost converter; and
a second gate connector connected to the boost capacitor of the boost converter of the buck-boost converter, and configured to provide a unidirectional path for current for energy stored in the inductor to transfer a second output during a second switch-off phase of a boost section of the buck-boost converter.

12. The fly-cap refresh circuit of claim 11,
wherein the inductor is configured to store energy during a charging phase and release the stored energy during a discharging phase of the buck-boost converter; and
wherein the inductor is configured to enable a voltage step-up and a voltage step-down functionality of the buck-boost converter while regulating a current flow to maintain an output voltage and minimize or reduce energy losses.

13. The fly-cap refresh circuit of claim 1,
wherein the first switching node of the buck converter is controlled based on a duty of the buck converter and a load current, and
wherein, the first switching node remains in an idle state for an extended period of time when the load current is low.

14. A system comprising:
a first fly capacitor connected to a buck capacitor of a buck converter of a buck-boost converter, and configured to prevent a discharge of the buck capacitor during one or more idle periods of a first switching node;
a second fly capacitor connected to a boost capacitor of a boost converter of the buck-boost converter, and configured to prevent a discharge of the boost capacitor during the one or more idle periods of the first switching node; and
a plurality of refresh switches connected between at least one of the first fly capacitor and the buck capacitor, the second fly capacitor and the boost capacitor, the first fly capacitor and a ground node, and the second fly capacitor and the ground node,
wherein the plurality of refresh switches are configured to activate based on an operational mode of the buck-boost converter to control enabling of a fly-cap refresh circuit of the buck-boost converter, and
wherein the operational mode comprises at least one of a Continuous Conduction Mode (CCM) or a Pulse Frequency Modulation (PFM) mode.

15. The system of claim 14,
wherein the first and second fly capacitor are configured to store a charge during one or more active switching periods to keep a voltage level of the buck and boost capacitors;
wherein one or more clock signals are configured to control the plurality of refresh switches; and
wherein the plurality of refresh switches are configured to refresh a charge in the buck and boost capacitors of the buck-boost converter.

16. The system of claim 14,
wherein the first fly capacitor is configured to store charge and supply charge to the buck capacitor of the buck converter;
wherein the second fly capacitor is configured to store charge and supply charge to the boost capacitor of the boost converter;
wherein a first refresh switch of the plurality of refresh switches is configured to activate and charge the first fly capacitor to an external voltage source minus a diode drop;
wherein a second refresh switch of the plurality of refresh switches is configured to activate and transfer charge from the first fly capacitor to the buck capacitor;
wherein a third refresh switch of the plurality of refresh switches is configured to activate and charge the second fly capacitor to the external voltage source minus the diode drop; and
wherein a fourth refresh switch of the plurality of refresh switches is configured to activate and transfer charge from the second fly capacitor to the boost capacitor.

17. The system of claim 14, wherein the operational mode of the buck converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the first switch and the second switch are configured to perform a buck switching based on at least one of a first signal and a second signal,
wherein the third switch is OFF, and the fourth switch is ON,
wherein during the buck switching, the buck capacitor is recharged as a second switching node associated with the first switching node operates by alternately connecting to the supply voltage source and a ground, wherein the buck capacitor is configured to charge based on the buck switching, and
wherein the boost capacitor is configured to charge based on at least two refresh switches of the plurality of refresh switches having a time period and a duty cycle,
wherein the first and second fly capacitors and the buck and boost capacitors are configured to stabilize an output voltage of the buck-boost converter, the buck capacitor is charged by a buck inductor and the boost capacitor is charged by the at least two refresh switches of the plurality of refresh switches, and
wherein the stabilized output voltage is delivered to a connected load, and the stabilized output voltage is determined based on the supply voltage source, a forward voltage of diode, a leak current, a refreshing frequency for boot-strap cap, and a first fly capacitor.

18. The system of claim 14, wherein the operational mode of the boost converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch a third switch, and a fourth switch,
wherein the third switch and the fourth switch are configured to perform a boost switching based on at least one of a first signal and a second signal,
wherein the first switch is ON and the second switch is OFF,
wherein during the boost switching, the buck capacitor is recharged as a second switching node associated with the first switching node operates by alternately connecting to the supply voltage source and a ground,
wherein the buck capacitor is configured to charge based on at least two refresh switches of the plurality of refresh switches having a time period (Ts) and a duty cycle, and
wherein the boost capacitor is configured to charge based on the boost switching.

19. The system of claim 14, wherein the operational mode of the buck-boost converter is the CCM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch (SW₁) (211), a second switch, a third switch, and a fourth switch
wherein the buck capacitor is configured to charge based on a buck switching; and
wherein the boost capacitor is configured to charge based on a boost switching.

20. The system of claim 14, wherein when the operational mode of the buck converter is the PFM, and the fly-cap refresh circuit further comprises:
a supply voltage source configured to provide power to the buck-boost converter; and
a plurality of switches configured to manage a flow of current within the buck-boost converter,
wherein each switch of the plurality of switches is an N-channel N-type Power Field-Effect Transistor switch,
wherein the plurality of switches includes a first switch, a second switch, a third switch, and a fourth switch,
wherein the buck capacitor is configured to charge during an idle state of a buck inductor based on continuous switching of at least two refresh switches of the plurality of refresh switches; and
wherein the boost capacitor is configured to charge during an idle state of a boost inductor based on continuous switching of at least two switches of the plurality of refresh switches.
